(19) United States
(12) Patent Application Publication
(10) Pub. No.: US 2002/0156651 A1
(43) Pub. Date: Oct. 24, 2002

(54) Prescription system for unregulated therapeutic substances

(76) Inventors: Vito V. Florio, Coral Springs, FL (US); Richard L. Michaels, Largo, FL (US)

Correspondence Address: MASON & ASSOCIATES, PA, 17757 US HWY 19 N., SUITE 500, CLEARWATER, FL, 33764, US

(21) Appl. No.: 09/837,490

(22) Filed: Apr. 18, 2001

(51) Int. Cl. G06F 17/60

(52) U.S. Cl. 705/2

(57) ABSTRACT

A system and method for coordinated evaluation and prescription of unregulated therapeutic substances in a supervised medical environment, wherein the unregulated therapeutic substances, derived from natural products, are initially qualified as a therapeutic option to traditional prescription and OTC medicines. The implementation of the system and method of qualification and prescription of unregulated therapeutic substances is performed within the context of a mainstream medical care environment comprising an established health care management system wherein patient subscribers, within a given system, elect to participate in a trial evaluation under the supervision of the medical professional responsible for their care. Upon successful completion of the evaluation, the patient is empowered, with his medical professional's approval, to adopt the unregulated therapeutic substances for treatment of his illness or condition, and the established health care management system is obligated to reimburse such patient for such unregulated therapeutic substances.

### BACKGROUND OF THE INVENTION

1. Field Of The Invention

This invention relates to system and to a method. More specifically, this invention relates to system for prescription of unregulated, herbal remedies and dietary supplements (collectively “Nutraceuticals” or “Natural Therapeutics”), as equivalent or superior treatment option to traditional ethical pharmaceuticals and/or over-the-counter medicines, within a supervised/mainstream medical care environment. This invention also contemplates the integration of the system of this invention within existing medical insurance plans and health care provider sponsored programs.

2. Description of the Prior Art

The increasing publicity and recognition of unregulated herbal remedies and dietary supplements, as equivalent or superior therapeutics to ethical pharmaceuticals, has and continues to create both promise and concerns. More specifically, in virtually all cultures a number of herbal remedies and dietary supplements have been validated as an acceptable method for treatment of various illnesses or conditions. More specifically, the dietary supplement, Vitamin C, have now been generally recognized as a prophylactic for the prevention and/or relief of the symptoms of the common cold. Similarly, herbal remedies, such as Echinacea has been recognized for its effectiveness in boosting the immune system; and, Green Tea extract in the prevention/reduction of the incidence of breast cancer.

Both the Indian and Asian cultures have been, and continue to be, the primary focus of naturally derived substances that are currently receiving increasing acceptance in western cultures. More specifically, in western Europe (particularly in Germany, Netherlands, Sweden), herbal therapeutics and dietary supplements are recognized by mainstream medicine as both viable and effective alternatives to the ethical pharmaceutical preparations. Such acceptance has been slow in coming within the United States because of medical establishment resistance and regulatory biases. Moreover, because such substances are “unregulated” in the sense that they do not require FDA approval for marketing in the USA, generally only a limited amount of data is available and accessible to support the safety and efficacy claims made for such products. Moreover, since these products are derived and/or extracted from naturally occurring substances, their potency and dosage can vary within broad limits and, thus, the potential for inconsistency in treatment or, alternatively, overdose is ever present. In addition, since only a limited amount of experience has been documented with a number of these substance, their potential for interaction with other herbals and/or prescription drugs, is for the most part, still unknown.

Increasingly, as both herbal remedies and dietary supplement (hereinafter collectively “Nutraceuticals”) become more accepted and more readily accessible to the public through health food stores, on-line pharmacies, and web-sites devoted to homeopathic medicines, individuals having chronic disorders and/or limited funds for prescription medicines, have increasingly begun administering these products to themselves with imperfect knowledge as to their efficacy and individual safety. The safety concern is most pronounced in the seniors' community where such Nutraceuticals are generally taken by an individual who is suffering from some other medical/aging disorder, and in conjunction with another medicine for such other disorder.

Unfortunately, the medical establishment in the United States has been slow to embrace changes in traditional medical practice, and in many instances has exhibited demonstrative hostility, to new and “unregulated” remedies such as Nutraceuticals. As noted above, one of the primary criticisms and concerns by the medical professional has and continues to be the absence of credible clinical data, the absence of establish standards relative to dosage and variation in quality depending upon the source and the manner of extraction/purification/compounding, etc.. The medical professional's reluctance to embrace such natural therapeutics is in no small measure based upon a well-founded concern for his/her potential professional liability for prescription of such Nutraceuticals.

Notwithstanding, the increasing recognition of the potential for good that such Nutraceuticals may have for individuals with chronic illness/disorders, without some means for prescription, delivery and supervision of the administration of such Nutraceuticals within a main stream medical care provider environments, their availability will continue to be limited to the dispensing thereof by non-medical personnel in an unsupervised environment. As such distribution and use continues to expand, the potential for harm and increasing pressure for regulatory restriction will grow.

The following is representative of the patent literature relating to the adaptation of advanced database management systems to the prescription of natural remedies in a mainstream medical practice

U.S. Pat. No. 5,797,839 (to Herscu, issued Aug. 25, 1998) relates to computer systems which facilitate the selection of homeopathic treatments stored in a database of a proprietary information system. The Herscu invention is designed to assist the physician practitioner in qualification of a patient for homeopathic treatment, remedy selection and treatment regimen. The system utilizes a predefined database of homeopathic information and facilitates patient qualification by prompting the homeopath for additional information based upon a state of the patient's symptoms. The system facilitates remedy selection by focusing the homeopath on the cycle of the disease and selecting remedies based upon such a model. The system facilitates treatment by allowing a historical record to be kept of each patient, thus, allowing the homeopath to track the course of disease and modify the treatment regimen, accordingly.

Notwithstanding the efforts described above (which are typical of efforts to legitimize the use and prescription of natural therapeutics), the Herscu approach falls far short of legitimizing homeopathic treatments, or for that matter attracting mainstream medicine to such homeopathic treatments. The failings of Herscu, and others, lies in the inability of such approaches to remove the basic and fundamental concerns of mainstream medicine in its adaptation and legitimization—the generally recognized lack in standards of manufacture and the variation in efficacy and potency depending upon the source of the supply. This resistance of the Nutraceutical industry to government imposed standards, and manifest lack of interest in self-regulation, has and continues to create distrust and confusion among medical professionals, and resistance to prescription of such natural therapeutics because of the uncertainties in their safety and effectiveness.

Thus, there continues to exist both a need to fully exploit naturally derived Nutraceuticals which, although largely undocumented, have proven efficacious, while at the same time protecting the unsuspecting individual from making an uniformed decision as to one or more of these natural therapies. Of equal importance is to accomplish this dual objective within mainstream medicine to insure proper surveillance of the patient reaction and progress, while at the same time increasing the availability of such treatments through medical insurance and managed health care reimbursement programs. The requirement for mainstream medical care provider involvement is essential both to protect the patient and to avoid additional regulatory restriction on the availability of such natural products, which, if it occurs, can only increase their cost and reduce their availability.

### OBJECTS OF THE INVENTION

It is the object of this invention to remedy the above as well as related deficiencies in the prior art.

More specifically, it is the principle object of this invention to provide a system and method for prescription of unregulated Nutraceuticals compounds within a mainstream medical care environment.

It is another object of this invention to provide a system and method for prescription of unregulated Nutraceuticals compounds within a mainstream medical care environment, wherein a medical professional is involved throughout the qualification of a patient as a candidate for an equivalent or superior therapy for treatment of such illness or medical disorder.

It is yet another object of this invention to provide a system and method for prescription of unregulated Nutraceuticals compounds within a mainstream medical care environment wherein a medical professional is involved throughout the evaluation of the safety and effectiveness of an natural therapy for treatment of patient suffering from an illness or medical disorder.

Additional objects of this invention include the adaptation of the system and method of this invention to continuing education of the medical professional and the patient relative to natural therapy choices specific for the patient's illness/disorder to further encourage patient and physician understanding and involvement in such equivalent or superior natural treatment options.

### SUMMARY OF THE INVENTION

The above and related objects are achieved by providing a system and method for evaluation and/or qualification of unregulated therapeutic substances or dietary supplement (herein also collectively “Nutraceuticals”), in a novel treatment regimen for a given illness or condition, as an equivalent or superior to traditional treatment regimens with ethical pharmaceuticals and over-the-counter medications. In the system and method of the invention an established health care maintenance organization (HMO, PPO) or health insurance company (collectively “Mainstream Medical Care Environment”) undertakes an evaluation program of a Nutraceuticals within its existing population of patient subscribers, under the medical supervision of medical professionals responsible for treatment of patient subscribers within an established medical care provider system. In the context of this invention, an established medical care provider, such as a Health Maintenance Organization (HMO) or Preferred Provider Organization (PPO) or an Insurance Company Sponsored Medical Reimbursement Plan (ICSP), would (a) initially identify a number of patient subscribers within its membership base; (b) solicit patient interest in participation in a trial evaluation program of a Nutraceutical as an equivalent or superior to traditional treatment regimens presently being prescribed for medical management of the patients' condition or illness; and, (c) conduct a controlled trial evaluation of the Nutraceutical on the selected patient subscribers under the supervision of the medical professionals responsible for the medical management of the illness/disorder of the patient subscribers under their care. The medical professional would be provided with a Nutraceutical of a known quality and potency from a reputable source, to be administered in accordance with an established protocol to the selected patient subscribers under his care. The medical professional would be responsible for monitoring of the patient's progress, and reactions to the Nutraceutical, which would be noted and reported to the entity responsible for administration of the evaluation.

In order to attract patient subscribers to the evaluation, the HMO would underwrite the treatment by compensation of the medical professional for his customary office visit charges, and provide similar incentives to the patient subscriber, that could include an insurance premium waiver or reduction. It is believed that affording patients the opportunity to participate in an evaluation of a Nutraceutical as an equivalent or superior therapy to traditional treatment for management of their illness or disorder, including the receipt of additional diagnostic services and cost free product, would be more than adequate incentive to attract the requisite number of participants in the trial of the natural therapeutic. Moreover, the anticipated increase in patient involvement, specifically, the access to educational materials and feed-back on his and other participant's progress would also encourage individual participation. The educational tools provided to both the medical professional and to the patient subscriber would be designed to create a patient subscriber awareness of the dangers of self-medication, medical professional access to the patient desirous of natural therapy treatment and, thus, discourage patient experimentation with potentially harmful products in an unsupervised environment. The benefits attainable from this approach include better medicine, less risk to the patient and lower cost to the HMO.

In one of the preferred embodiments of this invention, the Nutraceutical Supplier would support the evaluation by provision of educational tools, to both the medical professional responsible for the patient subscribers participating in the evaluation process, and to the selected patient subscribers. These tools could be in the form of an Internet based service that would provide answers to user questions; and, searchable database services, including a technical reference article collection, related to the natural therapeutics and dietary supplements, to alert the medical professional and patient to (a) contra indications and (b) potential interactions between the natural therapy and prescription medication, and/or other substances, that may be present/circulating within the selected patient subscribers' systemic system.

In another of the preferred embodiments of this invention, the medical professional would be encouraged, and given an opportunity, to participate in the comprehensive evaluation of the selected patient subscribers' nutritional needs and deficiencies, as part of, and preliminary to his evaluation of the specific natural therapeutic. The creation of a patient subscriber profile relative to nutrient levels, may under certain circumstance, disqualify a patient subscriber from participation in the evaluation of the natural therapy, or, alternatively, mandate the prescription of supplements in conjunction with the natural therapy. Thus, the natural therapy evaluation would necessarily address the patient subscribers' inventory of essential nutrients and supplement any nutrient found lacking, or below optimum levels, in order to insure that the evaluation of the natural therapeutic would not be effected/compromised by such patient deficiency.

In another of the preferred embodiments of this invention, the administration of the evaluation of the Nutraceutical would involve the implementation of an interactive network between the participants, specifically, the established medical care provider (who initiates and is actively monitoring the results of the evaluation), the medical professional (who is supervising the evaluation), and the Nutraceutical Supplier (who is supporting both the independent medical professional and the patient subscriber with educational tools and products). Accordingly, each of these participants cooperates and supports the patient subscribers enrolled in the evaluation of the Nutraceutical in their own unique way; and, upon satisfactory completion of the evaluation thereof, makes such Nutraceutical available by prescription to the enrolled plan participants as a reimbursable treatment option/regimen. The use of the prescription process in administration of the Nutraceuticals is a critical feature of the system and method of this invention, both from the perspective of the medical professional, and from the perspective of the patient, because such process necessarily gains medical professional recognition of the efficacy of the natural therapeutic, in the writing of the prescription; and, patient recognition that such natural therapeutics are both potent and a potentially harmful substances that cannot be dispensed or taken other than under medical supervision to protect the patient's well-being.

Moreover, by adoption of the prescription process for evaluation of the Nutraceutical, the medical establishment (e.g. medical professional and managed health care provider) now can professionally control the qualification of administration of the natural therapeutic within a defined population, consistent with the safeguards of mainstream medical practice, and independent of the influence of pharmaceutical companies, the Bureau Of Biologics or the Food and Drug Administration.

The enrolled plan participants who elect to take the Nutraceutical are monitored, as before, by the independent medical professional responsible for overseeing their care; and, their progress and any reactions recorded within the database maintained by the Nutraceutical Supplier or HMO. These data are available to all database subscribers to confirm efficacy, and to alert them to any side-effects or interactions involving the natural therapeutic.

In addition, as new or improved Nutraceuticals are developed and become available, the database subscriber would be alerted to such developments, based upon his/her interests or medical condition, and product information and samples supplied to the independent medical professional for solicitation of potential interest from the enrolled plan participants under his care. Accordingly, if sufficient patient interest were generated for health care provider consideration of the new or improved substance as an natural therapeutic, another evaluation protocol for the new or improved natural therapeutic would be established, and the evaluation process repeated. The medical professional would be compensated for additional time and effort incident to their participation in the advancement of the treatment of its patients with Nutraceuticals (free educational materials & promotional/advertising of his office as an natural therapy service provider). The importance of the medical professional' role in this process cannot be over emphasized; and, the incentives available to the professional only limited by the enthusiasm and intensity with which the professional embraces this process. In addition to creating new fee-for-service options (e.g. the opportunity to evaluate a patient's nutritional needs and/or deficiencies), the professional now has the potential for expansion of the patient base by attracting new patients that have become disenchanted with their current/traditional treatment options, or who simply would prefer treatment in a medically supervised environment with a naturally occurring/derived therapeutic, than the present system of self-administration.

At each stage of the evaluation and prescription process, the medical professional is encouraged to become involved in the search for natural therapeutics, and compensated for his/her efforts for his re-education, and in the education of the enrolled plan participants under his care. The increased involvement of the medical professional in his own re-education, and in the decision making process, as to identification and consideration of natural therapeutics, shall progressively increase the availability of natural treatment options, and lower the cost of medication. Moreover, where the natural therapeutic regimen utilizes a naturally derived substance that can be more readily assimilated by the human body, the tolerance to such therapy is increased, and the potential interference with other therapeutics minimized. Moreover, because of improved assimilation of the naturally derived product, it is expected that such natural therapy can be prescribed at a lower dosage level and/or reduce the physiological load and stress upon the body's cleansing processes (kidneys and liver) required for clearance of synthetic medicine, and the by-products of such synthetic medicines.

### BRIEF DESCRIPTION OF THE DRAWINGS

FIG. 1 is an illustration of an overview of the system and method of this invention.

FIG. 2 is an is an illustration of an expanded view of the evaluation phase of the system and method of FIG. 1.

FIG. 3 is an illustration of an expanded view of the facet of the system and method of FIG. 2 relating to the qualification of an individual for participation in the evaluation of a natural therapeutic.

FIG. 4 is an illustration of an expanded view of the system and method of FIG. 2 relating to the monitoring of the evaluation of natural therapeutic.

FIG. 5 is an illustration of an expanded view of the system and method of FIG. 1 relating to auditing of patient compliance with the prescribed natural therapy regimen.

### DESCRIPTION OF THE INVENTION INCLUDING PREFERRED EMBODIMENTS

In order to fully appreciate the context of this invention, and benefits to be derived from its implementation within an established Health Maintenance Organization (HMO), or comparable medical care service provider (PPO, Insurance Company Sponsored Plan, Union Sponsored Plan administered by a professional health care service provider, etc.), one must appreciate that past efforts at utilization of a systems approach to managed health care/medical practice has been resisted because of its perceived encroachment upon the physician/patient relationship, specifically, the independence of the physician in directing patient care. Accordingly, for any systems approach to delivery of medical services, within a managed health care environment, to be acceptable and endorsed by the mainstream medicine practitioner, it must first defer to the independent professional judgement of the physician in the formulation of the patient's care; recognize and respect the patient preferences in the selection of the treatment regimen for his illness or condition; and, be cost effective so as to reduce the cost of health care and the insurance premiums paid by the patient, or his employer.

The system and method of this invention can be a defined in terms of a hierarchical structure that is tailored for coordinated interactions between Nutraceutical suppliers and mainstream medical professionals to qualify, evaluate and administer natural products and/or naturally derived products, in the nature of dietary supplements and herbal remedies, and their respective combinations, (the so-called “Nutraceuticals”), within a mainstream medical environment. In addition, because such system and method are implemented within an established medical care provider environment, medical professional involvement is assured for continuity of patient care; and, patient experimentation, by self-administration of an unregulated substance or unknown quality and potency, is discouraged.

In, for example, the traditional HMO administered health delivery system, the HMO, through its employees, and medical professionals, under contract to the HMO, provide professional medical services to HMO patient subscribers, and compensate the medical professional based upon a set reimbursement schedule. The HMO defined system of health care, lists various treatment options and medications, suitable for physician prescription, which are reimbursable by the HMO. Generally, both the medical professional and patient subscriber options are constrained by the HMO, and the absence of such options is driven by the HMO desire to contain the cost of medical care. As set forth herein, the objectives of this invention further the HMO objectives of cost containment, while at the same time expand the treatment options available to the medical professionals and the patient subscribers, within a managed health care system, through the introduction of therapeutics, based upon natural substances and derivatives of natural substances (“Nutraceuticals”).

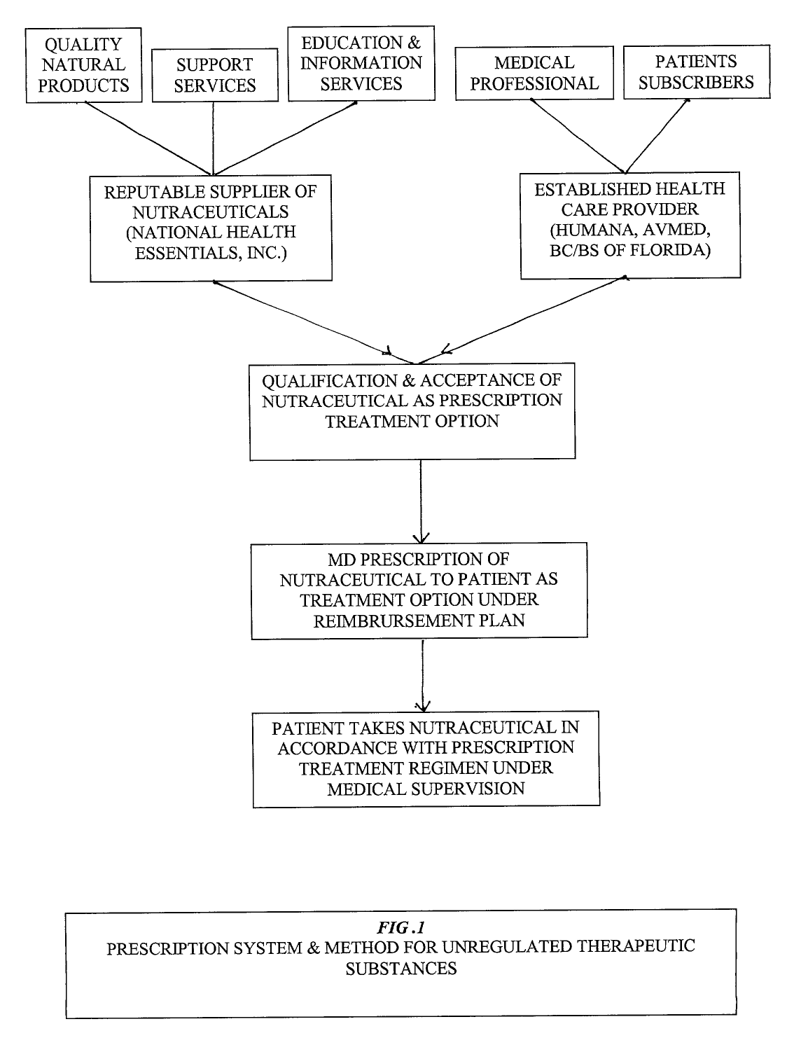

In the preferred embodiments of this invention illustrated in FIG. 1, the system and method of this invention is shown implemented within an established mainstream patient care treatment system administered through an established HMO. The system and method of this invention includes, as a participant, a Supplier of quality natural therapeutics and dietary supplements, identified as “NHE” (National Health Essentials). For the purposes of this illustration, the HMO utilizes the professional services of either employee and/or contract physicians to provide medical services to the patient subscribers of the HMO. The system assumes that each of the participants' self-interest is the primary motivational forces to both participation and to the success of the system. As noted herein, additional incentives to participation are available in one or more of the preferred embodiments of this system, were such is needed or desirable to generate interest in this evolutionary approach to medical management of disease and disorders commonly associated with aging. Upon evaluation and qualification of a Nutraceutical as a prescription option to physician and patient, the medical professional can prescribe the Nutraceutical in accordance with a therapeutic regimen, for medical management of the patients illness and/or disorder.

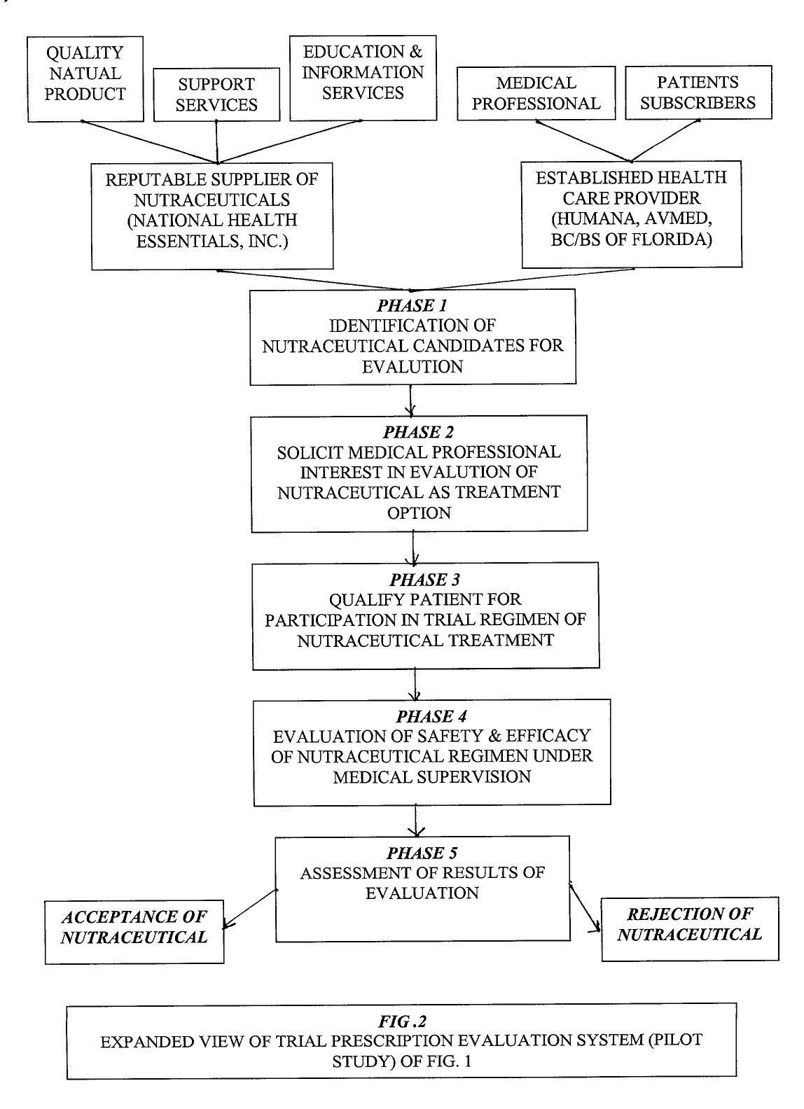

FIG. 2 further illustrates the interaction between the Supplier, the HMO, the medical professional and patient subscriber in the qualification of the patient to participate in the evaluation of the natural therapeutic through the ultimate acceptance of the Nutraceutical as a prescription option in the treatment of the patient. In one of the contemplated embodiments of this invention, such interaction is represented as a series of Phases (Nos. 1 to 5), leading ultimately to the rejection or acceptance of the Nutraceutical as a reimbursable prescription option.

Phase 1—Initially, the HMO either independently, or with the assistance of a Nutraceutical Supplier, identifies natural therapeutic candidates that have shown promise as an equivalent or superior treatment option to traditional prescription and/or over-the-counter medications. Having made such initial identification, the HMO independently, or with the assistance of a Nutraceutical Supplier, establish a protocol for evaluation of the natural therapy within the patient subscriber population of the HMO.

Phase 213 Subsequent thereto, the HMO, or its designee, contacts the medical professional responsible for care of the patient subscriber, whose treatment could potentially benefit from the Nutraceutical, to elicit potential interest in participation in the evaluation of the natural therapeutic. Alternatively, the HMO can contact its patient subscribers directly, or contact both the medical professional and the patient subscriber at about the same time, and encourage the setting of an appointment to discuss the natural therapeutic of potential benefit to the patient.

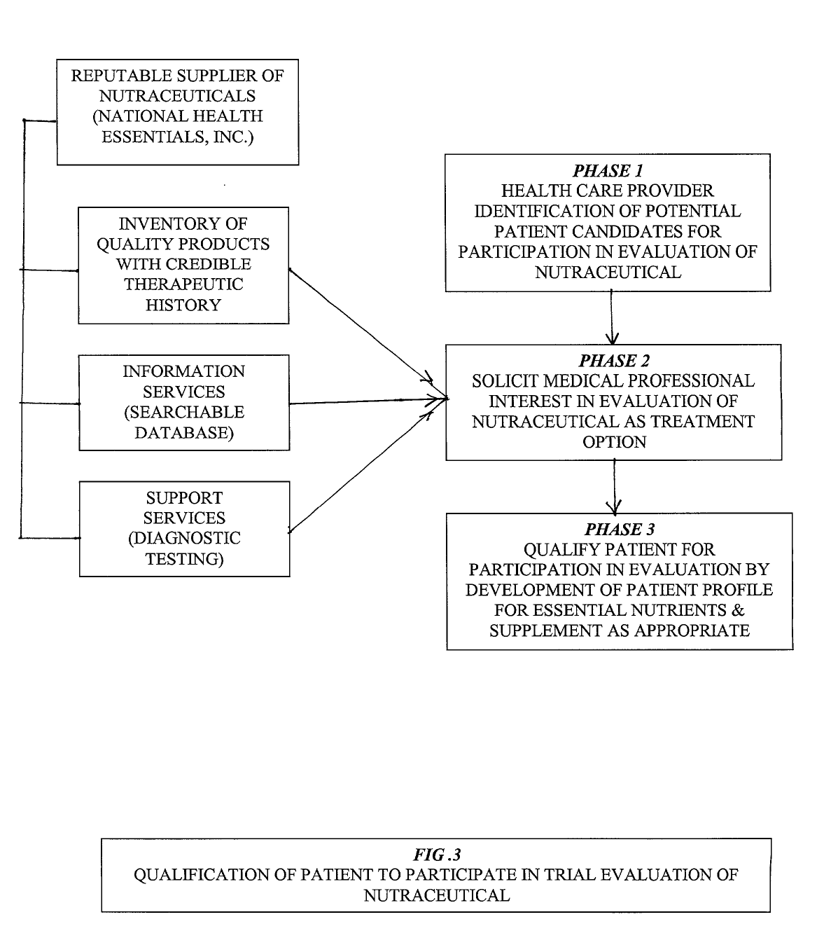

Phase 3—The medical professional would then qualify the patient subscriber expressing interest in the natural therapeutic as a participant in the trial evaluation of the natural therapeutic. This Phase involves confirming or updating the patient history, and initiation of a series of state-of-the-art diagnostic tests, at the expense of the HMO, to verify the nutritional health of the patient subscriber. More specifically, such diagnostic tests identify any deficiency in an essential nutrient or the presence of a substance indicative of a deficiency or a stress indicator, preliminary to his enrollment and participation in the evaluation of the specific natural therapeutic. The creation of a patient subscriber profile, relative to nutrient levels, as more fully illustrated in FIG. 3, may under certain circumstance, disqualify a patient subscribers from participation in the evaluation of the natural therapeutic, or mandate the prescription of supplements in conjunction with the natural therapeutic. Thus, preliminary to such natural therapeutic evaluation, the medical professional would initially address the patient subscribers' inventory of essential nutrients and supplement any nutrient found lacking, or below optimum levels, in order to insure that his participation in the evaluation of the natural therapeutic would not be effected/compromised by such deficiency.

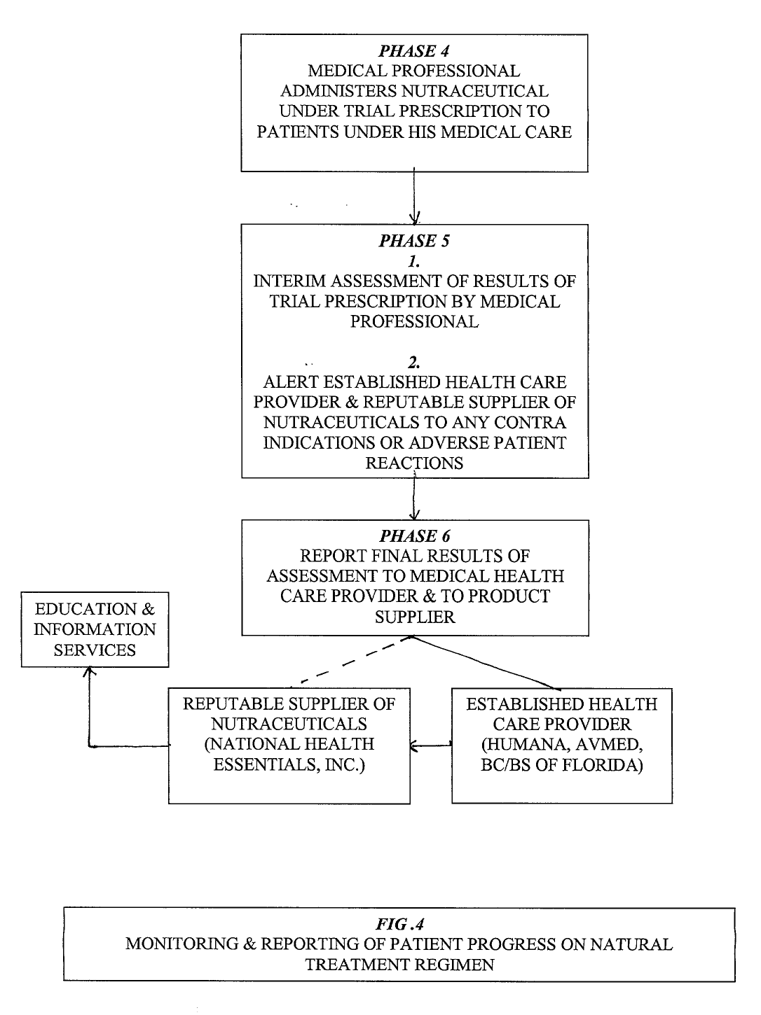

Phase 4—Assuming a sufficient number of patient subscribers are qualified to participate in the evaluation of the natural therapeutic, each patient would be provided with a trial prescription, much in the same manner as a prescription for an ethical pharmaceutical. The trial prescription would identify the Nutraceuticals by brand name, the dose and the dosage form, and the therapeutic regimen (frequency of administration) for the prescribed natural therapeutic. The patient would fill the prescription either through the medical professional's office, or directly from NHE, or some other entity participating in the evaluation, to insure integrity of the product used in the evaluation. The use of the prescription process in administration of the Nutraceuticals, as more fully illustrated in FIG. 4, is a critical feature of the system and method of this invention, both from the perspective of the medical professional and from the perspective of the patient because such process results in the medical professional recognition of the efficacy of the natural therapeutic, and the patient recognizes that such natural therapeutics are potent substances, that must be administered with medical direction and supervision to protect the patient's well-being (in the treatment of his illness and/or condition and adverse reactions or interactions with other medicines). Thus, the medical professional and managed health care provider each accept the administration of the natural therapeutic as integral with mainstream medical practice, thereby eliminate of the need and/or temptation for the patient to experiment with such natural therapeutics by self-administration.

Phase 5—The progress of the patient would be monitored, and any reactions to the natural therapeutic noted by the medical professional responsible for the patient's care. The assessment of the Nutraceutical for both safety and efficacy by the medical professional could include both traditional and possibly more efficient methods for maintaining surveillance of the patients' compliance with therapeutic regimen on the trial prescription. For example, the patient monitoring can involve direct contact with the patient (e.g. periodic office visits), or indirect periodic contact via email or facsimile or telephone, to confirm that the patient subscriber is adhering to the treatment regimen. Such indirect monitoring could be accomplished by polling of the patient by the HMO in accordance with a set reporting schedule, with the HMO alerting the medical professional to any response that may require his personal examination of the patient subscriber. In one of the preferred embodiments of this invention, the Nutraceutical Supplier would also be concurrently provided with the data/report of the results from the HMO for each patient participant to insure that such information is properly distributed within the universe (other HMOs or Nutraceutical evaluation sites) that are also participating in the evaluation of the same Nutraceutical.

The monitoring is calculated to necessarily elicit information from the patient relative to changes in the medical condition and patient's overall reaction to the natural therapy. The information is preferably provided in response to a questionnaire that requests the patient subscriber answer specific questions in a specific order, and express the answer as a “scaled” response within a given range. For example, where the natural therapeutic is an a natural pain relief preparation for treatment of the symptoms associated with arthritis (e.g. INHOLTRA Natural Pain Relief Formula), a question relating to the patient subscriber subjective symptoms associated with “stiffness”, would request the patient to grade his condition on, for example, a scale of 1 to 10, before and after the undertaking treatment with the natural therapeutic. Similarly, the patient would also be requested to report on other symptoms associated with arthritis (e.g. pain, fatigue, lack of concentration), on a similar scaled response basis. The questionnaire would also be particularly interested in eliciting information as to any other changes in the patient's well being (e.g. contra indications), specifically, anything that would indicate a reaction to the natural therapeutic (e.g. intestinal distress, nausea, allergic reactions, increase in pulse or palpitations, changes in equilibrium, blurred vision, etc.). It is anticipated that the comprehensive steps, taken in the qualification of the patient subscriber to participate in the evaluation of the natural therapeutic, would eliminate or minimize the occurrences of such reactions to the natural therapeutic, however, for this reason, monitoring by direct periodic contact between the medical professional and patient subscriber is preferred, at least for a brief period following the commencement of the evaluation process.

In FIG. 3, the interaction between the Supplier of the Nutraceuticals, the medical professional and patient is set forth in greater detail. Both preliminary to, and at or about the time of initiation of the evaluation process, each of participants, specifically, the medical professional and the patient subscriber, would receive information relative to the natural therapeutic and the evaluation process contemplated by the HMO. The information could also be distributed by and/or through the HMO, or by the Supplier of the Nutraceuticals, to each of the medical professionals and patient subscribers identified by the HMO.

In order to increase the medical professional's and the patient's familiarity with both the natural therapeutic (and possibly information related to the evaluation process), each of these potential participants would be encouraged to independently access an information service maintained by the Supplier of the Nutraceuticals. The information would include a searchable database or bibliography containing technical articles of varying sophistication, and most preferably a “Q & A” web page, or email address, to answer questions that such individuals may have. Access could be provided on multiple levels, a professional level having more detailed technical articles, and a patient or layman level with information presented in a more readily understandable (less technical) format. In each instance, the maintenance of this information service would be the responsibility of the Supplier of the Nutraceuticals, who would periodically update the information available, based upon data from the ongoing evaluation, or with topical literature or with product specifications, as it became available.

User access to, and familiarity with, the information services available on the information services maintained by the Supplier of the Nutraceuticals, greatly simplifies not only the administration and support of the evaluation process; but also, subsequent to qualification of the natural therapeutic, the fulfillment of the supply requirements of the patient subscribers in the filling of their prescriptions for the natural therapeutic.

As more fully illustrated in FIG. 4, once the Nutraceutical has been identified and qualified for trial prescription on a select patient population, the medical professional's roles is increasingly critical because of the monitoring and assessment of patient response to the Nutraceutical therapy.

Phase 4—Within the limits of the evaluation protocol, the medical professional prescribes the Nutraceutical in accordance with a therapeutic regimen specific for the individual patient's needs; and, thereafter, adjusts the treatment regimen, as appropriate, consistent with safety and efficacy objectives of the trial. The medical professional is solely responsible for the assessment of the patient reaction and progress to the natural treatment regimen.

Phase 5—The patient's progress and reactions are reported periodically (consistent with the protocol established for the evaluation); and, it is the responsibility of the medical professional to alert other participants in the trial to any observations or patient reactions that are significant from either an efficacy or safety perspective. This reporting can be accomplished via computer terminal networking with both the established health care provider and the supplier of the Nutraceutical.

Phase 6—Because of the relatively subjective nature of the evaluation, both the raw data and the medical professional's interpretation thereof would be included in his final report. Where the trail evaluation of the Nutraceutical is being conducted at multiple sites serviced the established health care provider, the networking between the medical professional at such sites and a central data processing center becomes even more important from an information dissemination function.

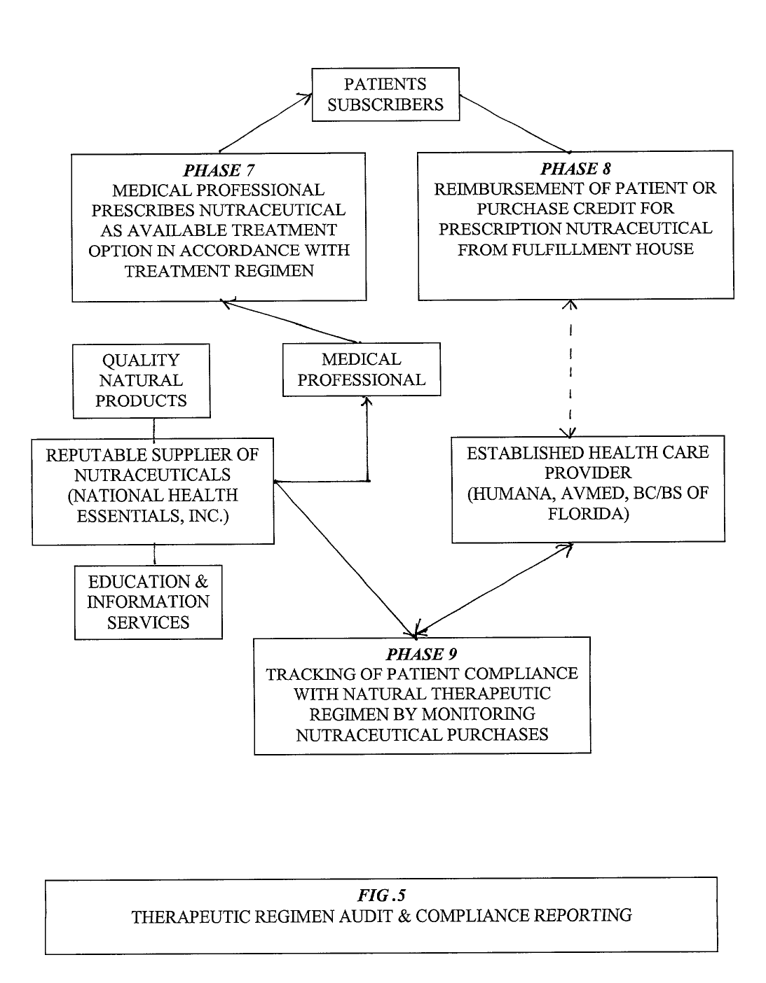

Phase 7—As more fully illustrated in FIG. 5, once the natural therapeutic has been qualified for prescription by the professionals affiliated with the HMO, it is listed as reimbursable medication on the HMO approved list of medicines. Because of the previously noted lack of standards for such natural products, and the derivatives of the natural products, the prescription would only specify brand name products evaluated and endorsed by the HMO, so as to insure both efficacy and safety of the natural therapeutic dispensed to the HMO's patient subscribers.

Phase 8—At this juncture, active HMO involvement, (except for reimbursement of the patient, or the fulfillment house/Supplier, for Nutraceutical purchases), in the process is essentially complete. The fulfillment of the prescription needs of the patient subscriber for the natural therapeutic is now administered by the Supplier of the Nutraceuticals, in cooperation with the medical professional, who can elect to either supply his patients directly (as shown in FIG. 5), or through referral of the patient to the Supplier's fulfillment house.

Phase 9—In one of the preferred embodiments of this invention, also illustrated in FIG. 5, each of the HMO and/or Supplier would maintain a tracking system to confirm patient prescription usage consistent with the therapeutic treatment regimen for the prescribed Nutraceuticals. More specifically, in each instance where a prescription is filled and reimbursement paid, or credited to the patient's account with a Nutraceuticals Supplier or at the fulfillment house, each of the medical professional and HMO would monitor such activity, and confirm to the medical professional that the patient consumption of Nutraceutical is in compliance with his/her treatment regimen. This tracking system not only confirms the patient subscriber compliance with his prescribed natural treatment regimen, but also protects the HMO and the medical professional from potential claims caused by a patient's departure from the prescribed treatment regimen.

As a result of the foregoing interactions, the relationship between the patient and medical professional has now been positively improved over that which existed before introduction of the natural therapeutic into the treatment regimen, except that the patient subscriber is presumably better able to tolerate the natural products. Such improvement is realized as incidental to the participatory nature of this interactive process wherein each of the participants is now participating in the decisions relating to the treatment options that are to be included within the available therapeutics and treatment regimens.

The foregoing description of this invention has been provided as illustrative of a number of the preferred embodiments thereof and is not intended as defining the metes and bounds of the invention, which has been reserved for the following claims.

What is claimed is:

1. In a mainstream medical care environment having employee physicians or affiliate medical professionals for delivery of health care services to a patient population wherein a number of said patients are being treated with a limited number of approved traditional therapeutic medicines in accordance established therapeutic regimens for such approved traditional therapeutic medicines,
wherein the improvement comprises:
A. Providing a mainstream medical care environment comprising an established health care management system staffed by employee physicians or affiliate medical professionals having responsibility for treatment of a defined patient population, or patient subscribers, with traditional medicines for a given medical condition;
B. Means for identification of an unregulated, therapeutic substance, as a natural for treatment of said given medical condition within said established health care management system;
C. Means for alerting said employee physicians or affiliate medical professionals responsible for overseeing the care of patients for said given medical condition, of the availability for evaluation, within said established health care management system, of said therapeutic substance as an natural treatment of said given medical illness or condition;
D. Means for soliciting said employee physicians or affiliate medical professionals, and their patients suffering from said given medical illness or condition, to participate, within said established health care management system, in said evaluation of said therapeutic substance;
E. Means for qualifying said patients, within said established health care management system, for participation in said evaluation of said therapeutic substance within said established health care management system;
F. Means for administering said therapeutic substance, within said established health care management system, in accordance with an natural therapeutic treatment regimen, under supervision of said medical professional; and
G. Means for monitoring patient response to said therapeutic substance, within said established health care management system, and if efficacious in said natural therapeutic regimen, empowering said patient to specify said therapeutic substance as an natural treatment for his medical illness or condition.

2. The improved mainstream, health care management system of claim 1, wherein said established health care management system includes means for periodically collecting and cataloging data of patient response to said natural therapeutic regimen over the course of such evaluation.

3. The improved mainstream, health care management system of claim 2, wherein said established health care management system includes means for disseminating, to medical professional and patient, up to date technical and product information related to said given medical condition.

4. The improved mainstream, health care management system of claim 1, wherein said established health care management system includes means for supply of said natural therapeutic to patients pursuant to a prescription for said natural therapeutic regimen.

5. The improved mainstream, health care management system of claim 1, wherein said mainstream, health care management system provides for patient reimbursement or insurance coverage for said natural therapeutic dispensed pursuant to a prescription written by said medical professional.

6. In a method for prescription of an unregulated, natural substance, or an unregulated derivative of a natural substance, as an natural therapeutic for treatment of said given medical condition within a mainstream medical care environment, the improvement comprising:
A. Providing a mainstream medical care environment comprising an established health care management system staffed by employee physicians or affiliate medical professionals having responsibility for treatment of a defined patient population, or patient subscribers, with traditional medicines for a given medical condition;
B. Identifying an unregulated, therapeutic substance, as a natural for treatment of said given medical condition within said established health care management system;
C. Alerting said employee physicians or affiliate medical professionals responsible for overseeing the care of patients for said given medical condition, of the availability for evaluation, within said established health care management system, of said therapeutic substance as an natural treatment of said given medical illness or condition;
D. Soliciting said employee physicians or affiliate medical professionals, and their patients suffering from said given medical illness or condition, to participate, within said established health care management system, in said evaluation of said therapeutic substance;
E. Qualifying said patients, within said established health care management system, for participation in said evaluation of said therapeutic substance within said established health care management system;
F. Administering said therapeutic substance, within said established health care management system, in accordance with an natural therapeutic treatment regimen, under supervision of said medical professional; and
G. Monitoring patient response to said therapeutic substance, within said established health care management system, and if efficacious in said natural therapeutic regimen, empowering said patient to specify said therapeutic substance as an natural treatment for his medical illness or condition.

7. In a method for control of the indiscriminate use of an unregulated natural substance and/or a derivative of a natural substance in the treatment of an illness or medical condition, the improvement comprising:
A. Providing a mainstream medical environment for evaluation of safety and efficacy of unregulated natural substance and/or a derivative of a natural substance, wherein a patient suffering from an illness or medical condition is initially evaluated within said environment to determine said substance's potential suitability for treatment of said patient;
B. Prescription of said substance within said environment by a medical professional for treatment of said patient in accordance with a treatment regimen specific for said patient; and
C. Periodic evaluation of said patient response to said substance by said medical professional.
